(19) United States
(12) Patent Application Publication
(10) Pub. No.: US 2018/0108458 A1
(43) Pub. Date: Apr. 19, 2018

(54) WIRE HARNESS ASSEMBLING DEVICE AND WIRE HARNESS MANUFACTURING METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tomohide MAKI, Mie (JP); Shigeto KATO, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 15/566,895

(22) PCT Filed: Aug. 18, 2016
(86) PCT No.: PCT/JP2016/074080

§ 371 Date: Oct. 16, 2017

(30) Foreign Application Priority Data
Sep. 3, 2015 (JP) 2015-173503

(51) Int. Cl. H01B 13/012; H01R 43/20

(52) U.S. Cl. CPC H01B 13/01209; H01R 43/20

(57) ABSTRACT

The present invention aims to provide technology for performing both the step of inserting terminals and the step of performing wiring, without transferring the wire harness or the electrical wires included therein between the steps. A wire harness assembling device includes: a connector bar that has a rod shape and to which a plurality of connectors can be set; a setting bar that has a rod shape and is configured to hold a plurality of terminal-equipped electrical wires; and a frame to which at least one set composed of the connector bar and the setting bar is attached such that the setting bar is located forward of the connector bar.

### TECHNICAL FIELD

The present invention relates to technology for manufacturing a wire harness.

### BACKGROUND ART

Steps that are taken to manufacture a wire harness include, for example, insertion of terminals, routing, and testing. Conventionally, a wire harness, or electrical wires that are included therein, is transferred between these steps, which results in an increase in the number of manufacturing steps.

To reduce the number of steps, technology for performing the steps of routing and testing without transferring a wire harness is disclosed in Patent Document 1, for example.

A wire harness manufacturing assistant device disclosed in Patent Document 1 includes: a base; a rotatable table that is provided on the base so as to be rotatable; and a wiring plate that is attached to the rotatable table and has a curved work surface, so that the time required to move the wire harness to perform wiring can be reduced. Furthermore, the wire harness manufacturing assistant device is provided with a camera that can capture an image of the work surface so that testing can be performed while wiring is performed.

### CITATION LIST

### Patent Document

Patent Document 1: JP 2009-238699A

### SUMMARY OF INVENTION

### Technical Problem

However, with the wire harness manufacturing assistant device disclosed in Patent Document 1, it is difficult to perform insertion of terminals and wiring without transferring the wire harness or the electrical wires included therein.

Therefore, the present invention aims to provide technology for performing both the step of inserting terminals and the step of performing wiring, without transferring the wire harness or the electrical wires included therein between the steps.

### Solution to Problem

To solve the above-described problem, a wire harness assembling device according to a first aspect includes: a connector bar that has a rod shape and to which a plurality of connectors can be set; a setting bar that has a rod shape and is configured to hold a plurality of terminal-equipped electrical wires; and a frame to which at least one set composed of the connector bar and the setting bar is attached such that the setting bar is located forward of the connector bar.

A wire harness assembling device according to a second aspect is the wire harness assembling device according to the first aspect, further including an attachment portion that enables the setting bar to be detachably attached to the frame.

A wire harness assembling device according to a third aspect is the wire harness assembling device according to the first or second aspect, further including: an electrical wire checking portion that is configured to check that terminal-equipped electrical wires are held by the setting bar that is in a state of being attached to the frame.

A wire harness assembling device according to a fourth aspect is the wire harness assembling device according to any one of the first to third aspects, wherein the connectors are provided so as to be slidable relative to the connector bar in a direction in which the connector bar extends, and so as to be able to change a state thereof between a slidable state and a non-slidable state.

A wire harness manufacturing method according to a fifth aspect includes: (a) a step of preparing a frame to which a connector bar and a setting bar such that the setting bar is located forward of the connector bar; (b) a step of setting a plurality of connectors to the connector bar according to a shape of a wire harness that is desired to be manufactured, and setting a plurality of terminal-equipped electrical wires so as to be held by the setting bar; (c) a step of inserting the terminal-equipped electrical wires into the connectors after the step (a) and the step (b) have been performed; and (d) a step of forming branches from the terminal-equipped electrical wires that extend from the connectors, after the step (c) has been performed.

A wire harness manufacturing method according to a sixth aspect is the wire harness manufacturing method according to the fifth aspect, wherein the setting bar is detachably attached to the frame, and the wire harness manufacturing method further includes (e) a step of removing the setting bar from the frame after the step (c) has been performed and before the step (d) is performed.

A wire harness manufacturing method according to a seventh aspect is the wire harness manufacturing method according to the fifth or sixth aspect, further including: (f) a step of checking that the terminal-equipped electrical wires are held by the setting bar, after the step (b) has been performed and before the step (c) is performed.

A wire harness manufacturing method according to an eighth aspect is the wire harness manufacturing method according to any one of the fifth to seventh aspects, further including: (g) a step of sliding the connectors relative to the connector bar in a direction in which the connector bar extends; and (h) a step of changing a state of the connectors between a state of being able to slide relative to the connector bar and a state of being unable to slide.

### Advantageous Effects of Invention

According to the first to fourth aspects, the wire harness assembling device includes: a connector bar that has a rod shape and to which a plurality of connectors can be set; a setting bar that has a rod shape and is configured to hold a plurality of terminal-equipped electrical wires; and a frame to which at least one set composed of a connector bar and a setting bar is attached such that the setting bar is located forward of the connector bar. Therefore, the terminal-equipped electrical wires held by the setting bar can be inserted into the connectors that have been set to the connector bar. By setting the arrangement of the connectors so as to correspond to the shape of the wire harness that is desired to be manufactured, it is possible to set the positional relationship between the terminal-equipped electrical wires so as to correspond to the wire harness, at the same time as inserting the terminals. Furthermore, it is possible to form branches from the terminal-equipped electrical wires that extend from the connectors that have been set to the connector bar. With the above-described configuration, it is possible to perform both the step of inserting terminals and the step of performing wiring, without transferring the wire harness or the electrical wires included therein between the steps.

In particular, according to the second aspect, the wire harness assembling device further includes an attachment portion that enables the setting bar to be detachably attached to the frame. Therefore, by removing the setting bar from the frame after the terminals have been inserted, it is possible to prevent the setting bar from hindering the operation that is performed to form branches after the terminals have been inserted.

In particular, according to the third aspect, the wire harness assembling device further includes the electrical wire checking portion that is configured to check that the terminal-equipped electrical wires are held by the setting bar that is in the state of being attached to the frame. Therefore, it is possible to prevent, for example, an error from occurring when the terminal-equipped electrical wires are inserted into the connectors, thereby preventing defective products from being manufactured.

In particular, according to the fourth aspect, the connectors are provided so as to be slidable relative to the connector bar in the direction in which the connector bar extends, and so as to be able to change the state thereof between a slidable state and a non-slidable state. Therefore, the connectors can be brought into the non-slidable state when the connectors are desired to be non-slidable such as when the terminals are inserted, and can be brought into the slidable state when the connectors are desired to be slidable such as when branches are formed.

According to the fifth to eighth aspects, the wire harness manufacturing method includes: (a) a step of preparing a frame to which a connector bar and a setting bar such that the setting bar is located forward of the connector bar; (b) a step of setting a plurality of connectors to the connector bar according to a shape of a wire harness that is desired to be manufactured, and setting a plurality of terminal-equipped electrical wires so as to be held by the setting bar; (c) a step of inserting the terminal-equipped electrical wires into the connectors after the step (a) and the step (b) have been performed; and (d) a step of forming branches from the terminal-equipped electrical wires that extend from the connectors, after the step (c) has been performed. Therefore, it is possible to perform both the step of inserting terminals and the step of performing wiring, without transferring the wire harness or the electrical wires included therein between the steps.

In particular, according to the sixth aspect, the setting bar is detachably attached to the frame, and the wire harness manufacturing method further comprises (e) a step of removing the setting bar from the frame after the step (c) has been performed and before the step (d) is performed. Therefore, it is possible to prevent the setting bar from hindering the operation that is performed to form branches after the terminals have been inserted.

In particular, according to the seventh aspect, the wire harness manufacturing method further includes (f) a step of checking that the terminal-equipped electrical wires are held by the setting bar, after the step (b) has been performed and before the step (c) is performed. Therefore, it is possible to prevent, for example, an error from occurring when the terminal-equipped electrical wires are inserted into the connectors, thereby preventing defective products from being manufactured.

In particular, according to the eighth aspect, the wire harness manufacturing method further includes: (g) a step of sliding the connectors relative to the connector bar in a direction in which the connector bar extends; and (h) a step of changing a state of the connectors between a state of being able to slide relative to the connector bar and a state of being unable to slide. Therefore, it is possible to bring the connectors into a non-slidable state when the connectors are desired to be non-slidable such as when the terminals are inserted, and to bring the connectors into a slidable state when the connectors are desired to be slidable such as when branches are formed to slide the connectors.

### BRIEF DESCRIPTION OF DRAWINGS

FIG. 1 is a workflow diagram showing a wire harness manufacturing method according to an embodiment.

FIG. 2 is a laid-out plan view of an example of a wire harness that is manufactured using the wire harness manufacturing method according to the embodiment.

FIG. 3 is a perspective view showing connector bars according to the embodiment and a wire harness assembling device that includes the connector bars.

FIG. 4 is a partially enlarged view showing the connector bars according to the embodiment and the wire harness assembling device that includes the connector bars.

FIG. 5 is a side view showing a connector holding part according to the embodiment.

FIG. 6 is a side view showing the connector holding part according to the embodiment.

FIG. 7 is a partially enlarged view showing a setting bar according to the embodiment.

FIG. 8 illustrates how terminal-equipped electrical wires are set to a setting bar.

FIG. 9 illustrates how terminal-equipped electrical wires that have been set to a setting bar are inserted into connectors that have been set to a connector bar.

FIG. 10 illustrates how the terminal-equipped electrical wires are inserted into the connectors that have been set to the connector bars.

FIG. 11 illustrates how a connector bar is rotated.

FIG. 12 illustrates an electrical wire group processing device according to the embodiment.

FIG. 13 illustrates how primary branching points are formed in electrical wires.

FIG. 14 illustrates how secondary branching points are formed in electrical wires.

### DESCRIPTION OF EMBODIMENTS

### Embodiment

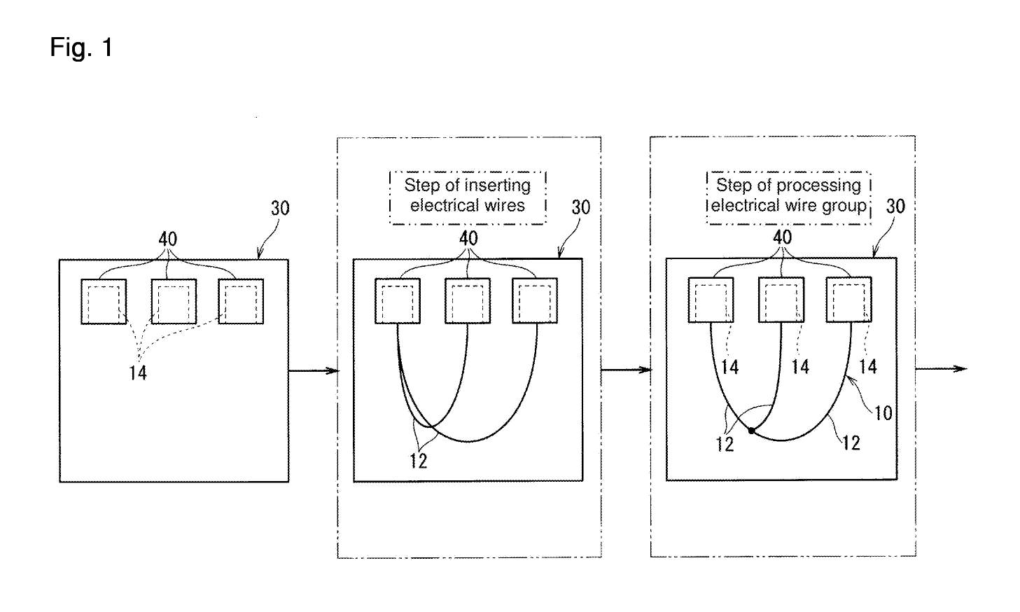

The following describes a wire harness assembling device according to an embodiment and a wire harness manufacturing method using the wire harness assembling device. Here, the overall flow of the wire harness manufacturing method according to the embodiment will be described first with reference to FIG. 1, and then the wire harness assembling device and each task will be described. FIG. 1 is a workflow diagram showing a wire harness manufacturing method according to the embodiment.

The first step of the wire harness manufacturing method according the embodiment is to prepare a plurality of connectors 14, a plurality of connector holding parts 40, and connector bars 30. The connector holding parts 40 are configured to hold the connectors 14. Each connector bar 30 is configured to support a plurality of connector holding parts 40. The connector holding parts 40 are set to the connector bars 30, and the connectors 14 are set to the connector holding parts 40.

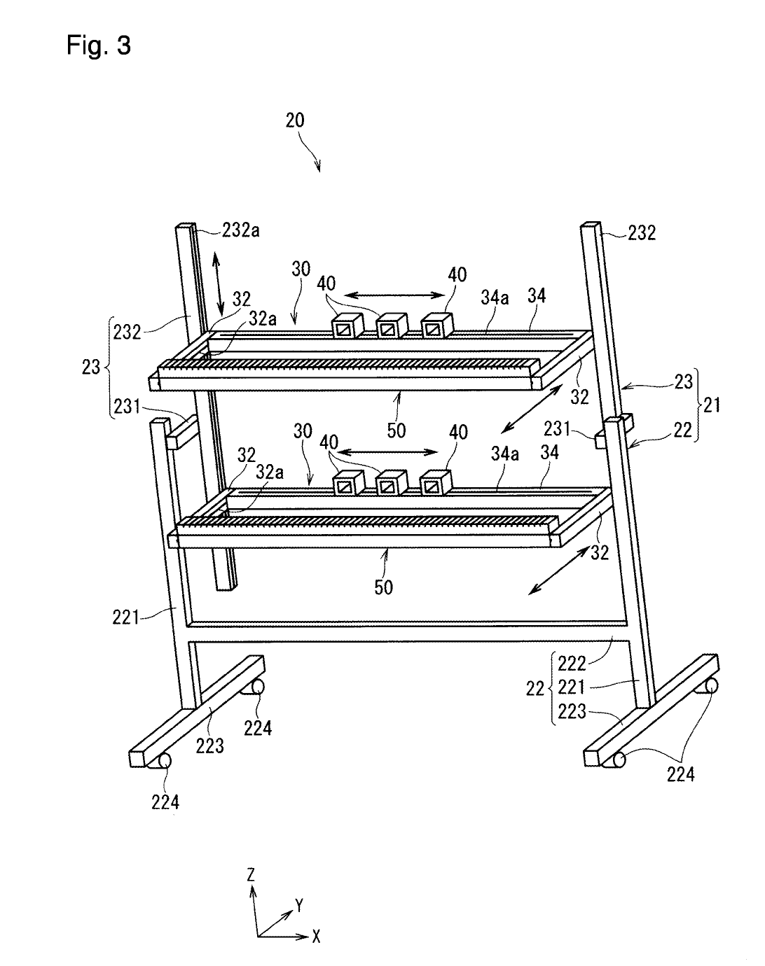

Next, the step of inserting electrical wires is performed. In the step of inserting electrical wires, terminal-equipped electrical wires 12 are inserted into the connectors 14 that have been set to the connector bars 30. Here, the connector bars 30 to which the connectors 14 have been set are attached to a wire harness assembling device 20 together with setting bars 50 (see FIG. 3). The setting bars 50 hold the terminal-equipped electrical wires 12 that are to be connected to the connectors 14. The terminal-equipped electrical wires 12 that have been set to the setting bars 50 are inserted into the connectors 14.

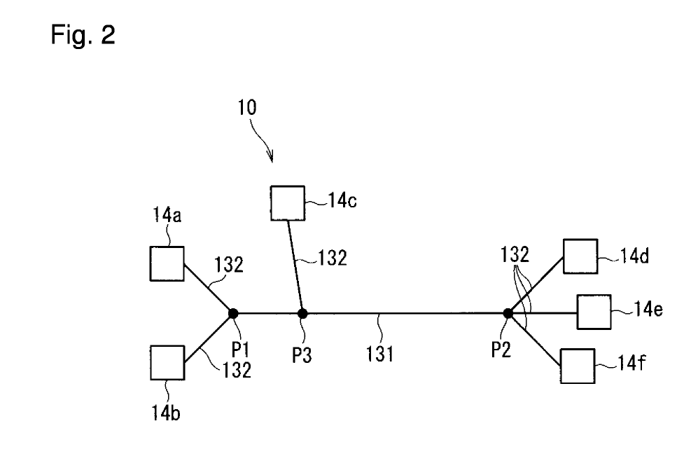

Next, the step of processing electrical wires is performed. In the step of processing electrical wires, branches from the terminal-equipped electrical wires 12 that extend from the connectors 14 are formed with the connectors 14 being set to the connector bars 30, and thus a wire harness 10 is formed. Specifically, when the terminal-equipped electrical wires 12 are inserted into the connectors 14, the terminal-equipped electrical wires 12 extend independent of each other. The task of keeping the plurality of terminal-equipped electrical wires 12, which extend independent of each other, in the form in which the terminal-equipped electrical wires 12 branch along installation routes in a vehicle, is performed. Note that, in FIG. 1, terminal-equipped electrical wires 12 that pass through the same route are represented as a single line. Therefore, in FIG. 1, it is possible that a single line actually represents a bundle of terminal-equipped electrical wires 12. The same applies to FIG. 2 and FIGS. 10 to 14.

Here, the wire harness 10 that is manufactured using the wire harness manufacturing method according to the embodiment will be described with reference to FIG. 2 as well. FIG. 2 is a laid-out plan view of an example of a wire harness 10 that is manufactured using the wire harness manufacturing method according to the embodiment.

The wire harness 10 that is to be processed has a configuration in which the plurality of terminal-equipped electrical wires 12 are divided into branches and tied together. From the branches of the wire harness 10, the terminal-equipped electrical wires 12 are inserted into and connected to the connectors 14. This wire harness 10 is built into a vehicle, and the connectors 14 are connected to various kinds of electronic components that are mounted on the vehicle. Thus, the wire harness 10 serves to electrically connect various kinds of electronic components that are mounted on the vehicle. The terminal-equipped electrical wires 12 included in the wire harness 10 are divided into branches and tied together according to installation routes in the vehicle.

An electrical wire 121 includes a core, which is a wire rod that is mainly made of a metal such as copper or aluminum, and an insulative coating that envelops the core. The insulative coating is, for example, a member that is mainly made of a synthetic resin such as polyethylene, vinyl chloride, or polyamide nylon.

As described above, the connectors 14 are connected to end portions of the electrical wires 121. The electrical wires 121 are connected to the connectors 14 via, for example, terminals 122 that are press-fitted or welded to, and thus connected to, the end portions of the electrical wires 121. Note that the terminals 122 are, for example, metal members that are mainly made of metal such as copper or tin.

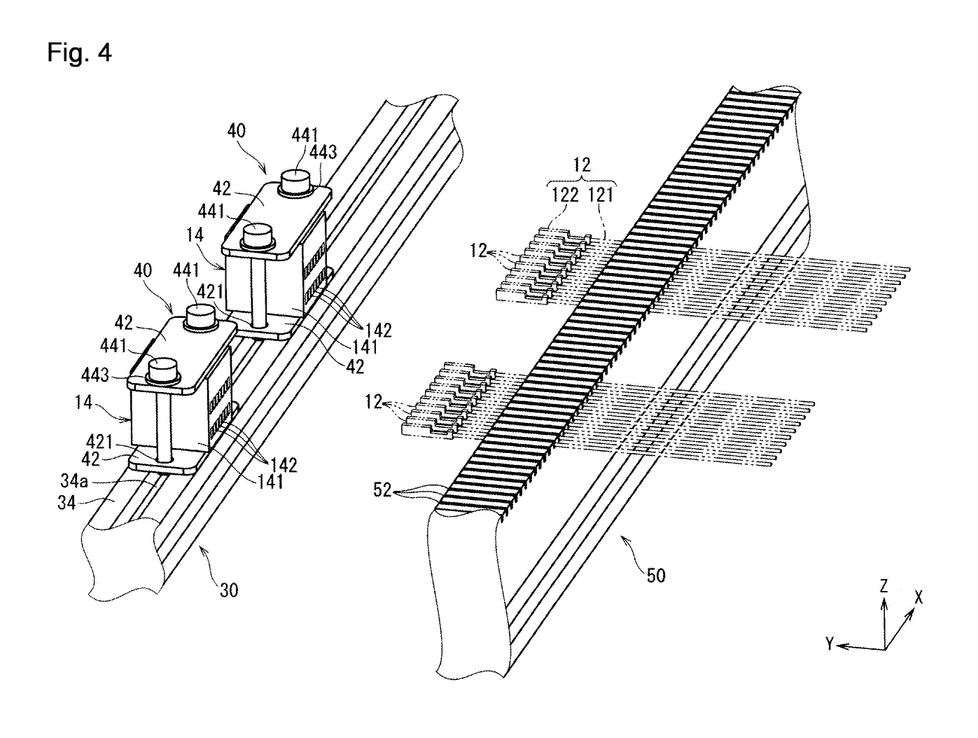

The housing 141 of each connector 14 is, for example, formed as an integrated piece using an insulative resin material such as a polybutylene terephthalate (PBT) or ABS resin. A plurality of cavities 142 are formed in the main surface, which is the surface to which electrical wires 121 are to be connected, of the housing 141 of each connector 14 (see FIG. 4).

The cavities 142 are open structures that house end portions (e.g. terminals 122) of electrical wires 121. Each cavity 142 has a certain depth in a direction that is, for example, substantially orthogonal to the main surface of the body of the connector 14. The electrical wires 121 housed in the cavities 142 are positioned and held at a predetermined depth in the cavities 142. Although the number of cavities 142 preferably corresponds to the number of electrical wires 121, the number is not particularly limited to such a number. In the present embodiment, a total number of fourteen cavities 142 are provided in rows and columns. However, it is only necessary that a plurality of cavities 142 are provided. In addition, it is not necessary that the cavities 142 have the same depth and the same width, and a cavity 142 that has a different depth and width may be included.

A connector 14 in which electrical wires 121 are held in the cavities 142 thereof is connected to a partner connector at a surface that is opposite the main surface thereof, for example.

In the following description, the case of manufacturing the wire harness 10 that branches off as shown in FIG. 2 will be described as an example. Of course, a wire harness 10 that has a different branch shape may be manufactured. In the wire harness 10, two branch lines 132 extend from an end portion of a trunk line 131 on one side, three branch lines 132 extend from an end portion of the trunk line 131 on the other side, and one branch line 132 extends from an intermediate portion of the trunk line 131. In this regard, connectors 14 are connected to end portions of the branch lines 132. In the following description, the connectors 14 are referred to as connectors 14a to 14f when they need to be specifically distinguished form each other.

In some cases, branching points are referred to as a primary branching point or a secondary branching point, in order from the connector 14 side. That is, a primary branching point is a branching point that is formed by assembling portions of electrical wires 121 that extend from connectors 14, relative to which no branching points are formed on the connector 14 side. A secondary branching point is a branching point that is formed between primary branching points, and relative to which no branching points are formed on either primary branching point side.

Specifically, in the wire harness 10 shown in FIG. 2, the point where the branch lines 132 that extend from the trunk line 131 to the connectors 14a and 14b branch off (a branching position P1) and the point where the branch lines 132 that extend from the trunk line 131 to the connectors 14d, 14e, and 14f branch off (a branching position P2) are primary branching points. Also, in the wire harness 10 shown in FIG. 2, the point where the branch line 132 that extends from the trunk line 131 to the connector 14c branches off (a branching position P3) is a secondary branching point.

Note that there is the possibility of a wire harnesses being only provided with primary branching points. There is also the possibility of three or more-ordinal branching points being provided.

### Wire Harness Assembling Device

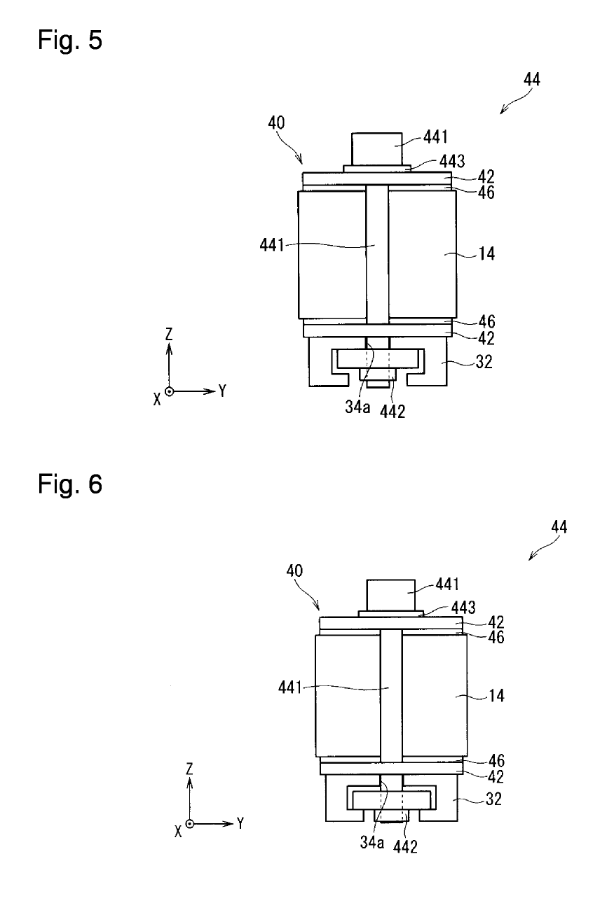

Next, the wire harness assembling device 20 to which the connector holding parts 40 and the connector bars 30 that hold the connector holding parts 40, and the connector bars 30 are attached will be described with reference to FIGS. 3 to 6 as well. FIG. 3 is a schematic perspective view showing the connector bars 30 according to the embodiment and the wire harness assembling device 20 that includes the connector bars 30. FIG. 4 is a partially enlarged perspective view showing a connector bar 30 according to the embodiment and the wire harness assembling device 20 that includes the connector bar 30. FIGS. 5 and 6 are side views showing a connector holding part 40 according to the embodiment. Note that the connector holding parts 40 in FIG. 3 are simplified. FIGS. 4 to 6 illustrate a connector 14 that has been set to a connector holding part 40.

The wire harness assembling device 20 in this example includes a frame 21, the connector bars 30, and the setting bars 50. The wire harness assembling device 20 in this example also includes an electrical wire checking portion 26.

The frame 21 includes a frame body part 22 and bar attachment parts 23. The frame 21 is provided so as to be able to support the connector bars 30.

The frame body part 22 is configured to support the bar attachment parts 23. More specifically, the frame body part 22 includes a pair of first rod-shaped portions 221, a second rod-shaped portion 222 that couples the pair of first rod-shaped portions 221 to each other, and third rod-shaped portions 223 that are respectively provided at end portions of the pair of first rod-shaped 221 on one side in the lengthwise direction. The first rod-shaped portions 221 extend in the vertical direction. The second rod-shaped portion 222 couples intermediate portions of the pair of first rod-shaped portions 221 in the lengthwise direction to each other, at positions that are closer to end portions of the first rod-shaped portions 221 on one side. The second rod-shaped portion 222 extends in a direction that is orthogonal to the lengthwise direction of the first rod-shaped portions 221. The third rod-shaped portions 223 extend from the edges of end portions of the first rod-shaped portions 221 on one side in the lengthwise direction, in a lateral direction that is orthogonal to the lengthwise direction of the first rod-shaped portions 221 and the lengthwise direction of the second rod-shaped portion 222. A pair of casters 224 are provided on the lower surface of each third rod-shaped portion 223. Thus, the wire harness assembling device 20 is movable.

In the following description, for the sake of convenience, the direction in which the second rod-shaped portion 222 in FIG. 3 extends is referred to as an x axis direction, the direction in which the third rod-shaped portions 223 in FIG. 3 extend is referred to as a y axis direction, and the direction in which the first rod-shaped portions 221 in FIG. 3 extend is referred to as a z axis direction, in some cases. In this regard, in the following description, it is assumed that the z axis direction is a vertical direction, and the x axis direction and the y axis direction are horizontal directions.

The bar attachment parts 23 are attached to the frame body part 22, and are configured to support the connector bars 30. More specifically, each bar attachment part 23 includes a coupling portion 231 and a first rail portion 232.

The coupling portions 231 each have a short rod shape, and are respectively connected to the pair of first rod-shaped portions 221 at positions that are closer to end portions of the first rod-shaped portions 221 on the other side in the lengthwise direction. In this regard, the coupling portions 231 are coupled to the first rod-shaped portions 221 so as to protrude from the first rod-shaped portions 221 in a direction that intersects the lengthwise direction of the first rod-shaped portions 221 (the y axis direction in this example).

The first rail portions 232 are respectively connected to edge side positions of the pair of coupling portions 231. In this example, intermediate portions of the first rails are attached to the coupling portions 231.

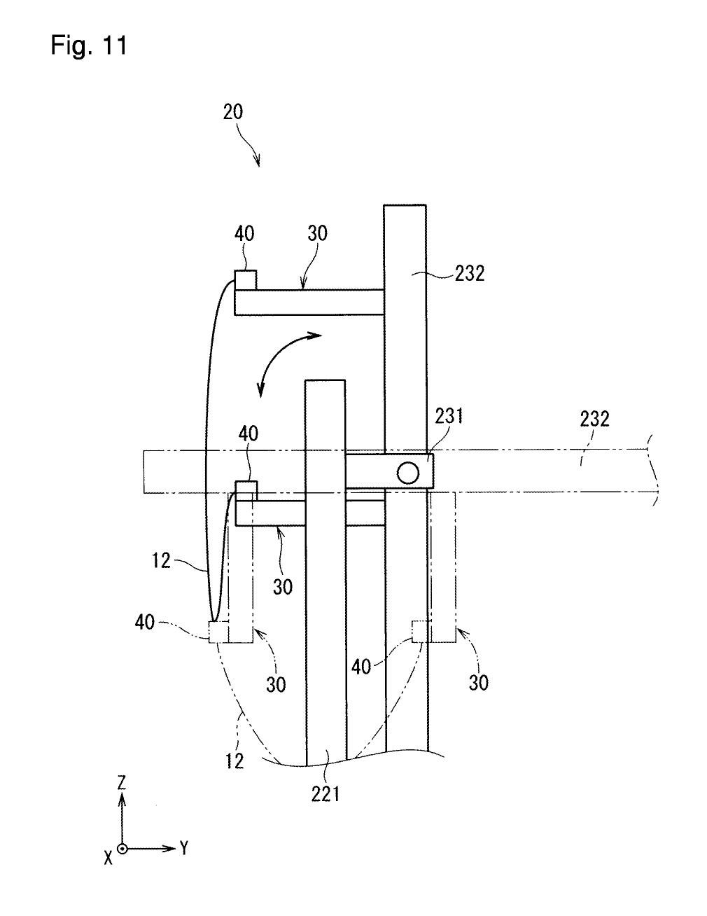

Also, the bar attachment parts 23 in this example are configured to be rotatable relative to the frame body 22. More specifically, in this example, the coupling portions 231 and the first rail portions 232 are coupled to the frame body 22 so as to be rotatable, as shown in FIG. 11. The range of rotation of the bar attachment parts 23 relative to the frame body 22 may be determined as appropriate. Preferably, each first rail portion 232 can change orientation from a state in which the lengthwise direction of the first rail portion 232 is the vertical direction to a state in which the lengthwise direction is the horizontal direction.

### Connector Bars

The connector bars 30 are attached to the bar attachment parts 23. In this example, each connector bar 30 is provided with a bar body part and connector holding parts 40. A plurality of connector holding parts 40 are attached so as to be arranged in a direction in which the bar body part extends. More specifically, each connector bar 30 includes a second rail portion 32 and a third rail portion 34. In the following description, it is assumed that the third rail portion 34 is an example of the bar body part.

The second rail portions 32 each have a rod shape, and are respectively attached to the pair of first rail portions 232. In this example, side surfaces of end portions of the second rail portions 32 on one side in the lengthwise direction are attached to the first rail portions 232 such that the second rail portions 32 extend in a direction (the y axis direction in FIG. 3) that is orthogonal to the lengthwise direction of the first rail portions 232 and to the direction that connects the pair of first rail portions 232. In addition, the second rail portions 32 are provided so as to be able to change position relative to the first rail portions 232 in the lengthwise direction of the first rail portions 232. In this example, the second rail portions 32 are provided so as to be slidable relative to the first rail portions 232 in the lengthwise direction of the first rail portions 232. Note that a configuration that enables the second rail portion 32 to slide relative to the first rail portion 232, as well as configurations that enable other slidable members to slide, will be described later in detail.

Each third rail portion 34 has a rod shape, and both end portions thereof are attached to a pair of second rail portions 32 such that the third rail portion 34 is interposed between the pair of second rail portions 32. The third rail portions 34 extend in the x axis direction. Each third rail portion 34 is provided so as to be able to change position relative to the corresponding second rail portion 32 in the lengthwise direction of the second rail portion 32. In this example, each third rail portion 34 is provided so as to be slidable relative to the corresponding second rail portion 32 in the lengthwise direction of the second rail portion 32.

Each bar body part is provided so as to be able to support a plurality of connector holding parts 40. In the example shown in FIG. 3, three connector holding parts 40 are provided for one bar body part. In this example, the bar body parts are provided so as to be able to directly support the connector holding parts 40 such that electrical wires 121 that extend from the connectors 14 that are held by the connector holding parts 40 dangle. The bar body parts can support a plurality of connector holding parts 40 that are arranged in a first direction (the x axis direction in this example) that is orthogonal to the vertical direction. Also, a plurality of bar body parts are provided so as to be arranged in a second direction (the z axis direction in the example shown in FIG. 3) that is orthogonal to the first direction. Also, each bar body part supports a plurality of connector holding parts 40 such that the connector holding parts 40 are slidable in the direction in which the bar body parts extend.

The following describes configurations that make it possible for members to be slidable relative to each other. Examples of configurations that make it possible for members to be slidable relative to each other include a configuration in which one of a pair of members that are slidable relative to each other is provided with a groove, and the other member is fitted into the groove and slides along the groove. In this regard, the other member may be directly attached to the one member so as to slide, or attached to the on member via another member so as to slide. Examples of the aforementioned other member include a slider member that is attachable to the other member, and is fitted to the groove so as to be slidable. In the following description, it is assumed that the members are slidable due to grooves being formed.

That is, each first rail portion 232 has a rod shape with a rectangular cross section, and a groove 232a that extends in the lengthwise direction of the first rail portion 232 (the z axis direction in the example shown in FIG. 3) is formed in one side surface of the first rail portion 232 as a configuration that enables a second rail portion 32 to slide relative to the first rail portion 232. In this example, the groove 232a is formed in side surfaces of the pair of first rail portions 232 that face each other (side surfaces that face each other in the x axis direction), out of the side surfaces of the first rail portions 232. Portions of the second rail portions 32 are fitted into the grooves 232a, and slide along the grooves 232a.

Similarly, each second rail portion 32 has a rod shape with a rectangular cross section, and a groove 32a that extends in the lengthwise direction of the second rail portion 32 (the y axis direction in the example shown in FIG. 3) is formed in one side surface of the second rail portion 32 as a configuration that enables a third rail portion 34 to slide relative to the second rail portion 32. In this example, the groove 32a is formed in side surfaces of each pair of second rail portions 32 that face each other (side surfaces that face each other in the x axis direction), out of the side surfaces of the second rail portions 32. Portions of the third rail portions 34 are fitted into the grooves 32a, and slide along the grooves 32a.

Also, each third rail portion 34 has a rod shape with a rectangular cross section, and a groove 34a that extends in the lengthwise direction of the third rail portion 34 (the x axis direction in the example shown in FIG. 3) is formed in one side surface of the third rail portion 34 as a configuration that enables a connector holding part 40 to slide relative to the third rail portion 34. In this example, when the first rail portions 232 are orientated in the vertical direction, out of the side surfaces of each third rail portion 34, the groove 34a is formed in a side surface that faces upward in the vertical direction. Portions of the connector holding part 40 are fitted into the grooves 34a, and slide along the grooves 34a.

It is preferable that the members that slide relative to each other can be fixed at any position or predetermined position in the sliding path. For example, bolts and nuts can be employed as configurations that enable the members that slide relative to each other to be fixed at any position or predetermined position in the sliding path. That is, when a pair of members that slide relative to each other reach desired fixing positions, the members are fixed at the positions by fastening a bolt and a nut. When it is desired to enable a pair of members to slide relative to each other, the members can be enabled to slide by loosening a bolt and a nut. In this regard, for example, if the bolt hole is elongated as with the groove along the groove, the pair of members that slide relative to each other can be fixed at any position. Also, for example, a plurality of bolt holes are provided along the groove, the pair of members that slide relative to each other can be fixed at predetermined positions.

Of course, configurations that enable the members that slide relative to each other to be fixed at any position or predetermined position in the sliding path are not limited to bolts and nuts. For example, it is possible to employ a configuration in which one of a pair of members that slide relative each other is provided with an operation portion and a protrusion that retracts in synchronization with the operation portion. That is, when a pair of members are desired to slide relative to each other, it is possible to slide the members by operating the operation portion to retract the protrusion. When the pair of members that slide relative to each other reach desired fixing positions, the members can be fixed at the positions by allowing the protrusion to protrude.

A plurality of connector bars 30 are provided so as to be arranged in a direction (the z axis direction in the example shown in FIG. 3) that is orthogonal to the lengthwise direction thereof. In this example, two connector bars 30 are attached to the bar attachment parts 23. In this example, the two connector bars 30 are attached so as bulge out toward the same side relative to the bar attachment parts 23, i.e. the second rail portions 32 protrude toward the same side relative to the first rail portions 232 (the negative side in the y axis direction in the example shown in FIG. 3). However, this is not essential. The two connector bars 30 may be attached so as to bulge out toward opposite sides (the positive side and the negative side in the y axis direction in FIG. 3) relative to the bar attachment parts 23.

It is preferable that the number of connector bars 30 is changeable. In this example, the connector bars 30 are detachably attached to the bar attachment parts 23. More specifically, the second rail portions 32 are detachably attached to the first rail portions 232. Hence, it is possible to change the number of connector bars 30 as appropriate according to the shape or the like of the wire harness 10 that is to be manufactured.

The connector holding parts 40 are attached to the bar body parts. In the following description, it is assumed that the connector holding parts 40 are directly attached to the bar body parts. Of course, the connector holding parts 40 may be indirectly attached to the bar body parts via another members.

### Connector Holding Parts

The following describes the connector holding parts 40 that hold the connectors 14. The connector holding parts 40 are configured to hold the connectors 14. More specifically, each connector holding part 40 in this example includes two sandwiching portions 42 and a fixing portion 44. Furthermore, the connector holding parts 40 in this example includes a buffer portion 46.

The two sandwiching portions 42 are provided so as to be able to sandwich a connector 14 between main surfaces thereof that face each other. In this example, each of the two sandwiching portions 42 have a flat shape. Of course, a third rail portion 34 may serve as one of the two sandwiching portions 42.

The fixing portion 44 supports the two sandwiching portions 42 so as to be relatively movable in a direction that is orthogonal to the main surfaces of the sandwiching portions 42 (the surfaces between which the connector 14 is sandwiched). The fixing portion 44 is provided so as to be able to fix the two sandwiching portions 42 in a state where the two sandwiching portions 42 sandwich the connector 14. Also, in this example, the connector holding parts 40 are attached to the third rail portions 34 by the fixing portions 44.

Specifically, a bolt insertion hole 421 into which a bolt 441 can be inserted is formed in each sandwiching portion 42. In this example, bolt insertion holes 421 are respectively formed at two positions of a sandwiching portion 42 that has a flat shape. A connector 14 is held by a connector holding part 40 so as to be located between two bolt insertion holes 421. Therefore, the distance between two bolt insertion holes 421 needs to be greater than or equal to the width of a connector 14 that has the maximum width among the connectors 14 that are to be held by the connector holding parts 40.

Each fixing portion 44 includes bolts 441 that are inserted into the bolt insertion holes 421 and nuts 442 that can fix the bolts 441 that are inserted into the bolt insertion holes 421. The distance between two sandwiching portions 42 can be changed in the direction in which the bolts 441 extend, with the bolts 441 being inserted into the bolt insertion hole 421 of the two sandwiching portions 42. The distance between two sandwiching portions 42 is changed according to the size of the connector 14, and the bolts 441 are fastened with the connector 14 being sandwiched between the sandwiching portions 42. Thus, the two sandwiching portions 42 are restricted by the connector 14 from moving in the direction in which the distance between the sandwiching portions 42 decreases. Also, the two sandwiching portions 42 are restricted by the bolts 441 and the nuts 442 from moving in the direction in which the distance between the sandwiching portions 42 increases. Consequently, the sandwiching portions 42 are fixed with the distance therebetween being constant. Note that a washer 443 is appropriately provided between, for example, the head of a bolt 441 and a sandwiching portion 42, and a nut 442 and a sandwiching portion 42.

The connectors 14 are provided so as to be able to slide relative to the connector bars 30 in the direction in which the connector bars 30 extend, and so as to be able to change the state thereof between a slidable state and a non-slidable state. In this example, the connector holding parts 40 are provided so as to be able to slide relative to the connector bars 30 in the direction in which the connector bars 30 extend, and so as to be able to change the state thereof between a slidable state and a non-slidable state. Specifically, connector holding parts 40 are attached to a third rail portion 34 so as to be able to slide in the direction in which the third rail portion 34 extends with bolts 441 being unfastened.

In this example, the bolts 441 are inserted into a groove 34a of a third rail portion 34, and the bolts 441 are slidable along the groove 34a with the bolts 441 being unfastened. By changing the state of each connector holding part 40 between a state in which the bolts 441 are unfastened (see FIG. 6) and a state in which the bolts 441 are fastened (see FIG. 5), it is possible to change the state thereof between a slidable state and a non-slidable state. Specifically, a nut 442 is attached to a leading end of a portion of a bolt 441 that passes through the groove 34a, with a portion of the bolt 441 that extends outward from the bolt insertion hole 421 relative to the sandwiching portions 42 being inserted into the groove 34a. Then, the nut 442 is fastened, and thus the connector 14, the sandwiching portions 42, and the third rail portion 34 are sandwiched between the bolt 441 and the nut 442. Consequently, the connector holding part is brought into a state of being unable to slide relative to the connector bar 30. Also, upon the nut 442 being unfastened, the connector 14, the sandwiching portions 42 and the third rail portion 34 are released from the state of being sandwiched between the bolt 441 and the nut 442. Due to the configurations above and the configuration in which the diameter of the nuts 442 is set to be smaller than the width of the grooves 34a (the size thereof in the y axis direction in FIG. 5), the connectors 14 and the connector holding parts 40 are slidable relative to the third rail portion 34.

Note that, in this example, the width of an intermediate portion of the groove 34a in the direction in which the bolt is inserted (the width in the y axis direction in FIG. 5) is set to be greater than the width of an end portion of the groove 34a. Thus, the nut 442 is prevented from falling off from the groove 34a.

Also, although the nut 442 is housed in the groove 34a in this example, it is possible that the head of the bolt 441 is housed in the groove 34a.

Due to the connector holding parts 40 being slidable in the direction in which the third rail portions 34 extend (the x axis direction in the example shown in FIG. 3), it is easy to adjust the positional relationship between the connectors 14 relative to each other. The connector holding parts 40 are detachably attached to the connector bars 30. Hence, it is possible to change the number of connector holding parts 40 as appropriate according to a wire harness 10 that is to be manufactured. Also, it is possible to attach connector holding parts 40 that meet the shape of the connectors 14 according to a wire harness 10 that is to be manufactured.

A buffer portion 46 is provided on a main surface of a sandwiching portion 42 so as to be able to be interposed between the sandwiching portions 42 and a connector 14. A buffer portion 46 is provided so as to buffer pressure that is applied to a connector 14 when two sandwiching portions 42 sandwich the connector 14. The buffer portion 46 can be made of an elastic material such as a butyl tape or a foam material so as to have a flat shape that is smaller than the sandwiching portions 42. Note that the buffer portion 46 may be fixed to or may not be fixed to a sandwiching portion 42. If a buffer portion 46 is fixed to a sandwiching portion 42, the buffer portion 46 can be bonded thereto using an adhesive, a tape, or the like. Since a buffer portion 46 is interposed between a sandwiching portion 42 and a connector 14, the connector 14 is unlikely to be damaged or displaced when the connector 14 is sandwiched between two sandwiching portions 42. Furthermore, since a buffer portion 46 is provided, a connector 14 is unlikely to be released from the sandwiched state when the bolt 441 is slightly unfasted in order to slide a connector holding part 40 relative to a connector bar 30.

Note that a plurality of types of connector holding parts 40 that include sandwiching portions 42 or bolts 441 with different lengths or the like can be prepared according to the size and so on of the connectors 14. For example, it is possible that two types of connector holding parts are provided, and connectors with a size that is smaller than a predetermined size are held by one of the connector holding parts and connectors with a size that is larger than or equal to the predetermined size are held by the other of the connector holding parts.

### Setting Bars

The setting bars 50 are configured to hold a plurality of terminal-equipped electrical wires 12. The setting bars 50 are attached to the frame 21. In this example, the setting bars 50 are attached to the frame 21 with the connector bars 30 interposed therebetween.

More specifically, in each setting bar 50, a plurality of electrical wire holding portions 52 that are configured to hold electrical wire end portions of the terminal-equipped electrical wires 12 are arranged along a straight line such that the electrical wire end portions can be held in parallel with each other. Here, the electrical wire end portions of the terminal-equipped electrical wires 12 are end portions of portions of the electrical wires 121 where core wires are covered by coating portions, and are portions on the side of base end portions of the terminals 122 that are press-fitted to exposed core wire portions. More specifically, each setting bar 50 has an elongated shape as a whole, and includes a plurality of electrical wire holding portions 52 and a setting bar body portion 55.

The electrical wire holding portions 52 are portions that hold the electrical wire end portions of the terminal-equipped electrical wires 12, and each include a pair of elastic sandwiching pieces 53 and a sandwiching piece fixing portion 54.

The elastic sandwiching pieces 53 are members that are formed by, for example, punching out and bending a plate-shaped metal material, and include a flat plate on the base end side and a curved portion on the leading end side. More specifically, the flat portion has a plate shape, and the curved portion that is continuous with the flat portion and is smoothly curved along an S shape.

Each sandwiching piece fixing portion 54 is a portion that supports a pair of elastic sandwiching pieces 53, and is made of a synthetic resin or the like and has a substantially rectangular parallelepiped shape as a whole. Each sandwiching piece fixing portion 54 is configured to support a pair of elastic sandwiching pieces 53 such that the leading end portions of the elastic sandwiching pieces 53 are separated from each other and the flat portions come up against each other (back to back). More specifically, each sandwiching piece fixing portion 54 has an opening in one end surface thereof, and has a recessed portion into which a pair of elastic sandwiching pieces 53 can be inserted via the opening. A wall portion is formed inside the sandwiching piece fixing portion 54, the wall portion supporting the pair of elastic sandwiching pieces 53 on the bottom side such that flat portions of the elastic sandwiching pieces 53 come up against each other in a sandwiched state. Each sandwiching piece fixing portion 54 supports a pair of elastic sandwiching pieces 53 that are fitted thereinto, such that portions of the curved portions near the leading end portions are close to each other and the gap therebetween is smaller than the diameter of the electrical wires 121 of the terminal-equipped electrical wires 12 (the case where the portions of the curved portions are in contact with each other is included).

The electrical wire end portion of a terminal-equipped electrical wire 12 is inserted between a pair of elastic sandwiching pieces 53, and thus the electrical wire end portion is held by being surrounded by the portions, which are close to each other, of the curved portions of the pair of elastic sandwiching pieces 53 and an end surface of the sandwiching piece fixing portion 54 on the side of the opening.

Note that the above-described electrical wire holding portions 52 are examples and may have other configurations. For example, a configuration that includes a comb teeth-like member and holds the electrical wire end portions of the terminal-equipped electrical wires 12 that are inserted into and hooked to the gaps between the comb teeth may be employed as electrical wire holding portions.

The setting bar body portion 55 has a rod shape (a rectangular rod shape in this example), and the plurality of electrical wire holding portions 52 described above are supported in parallel with each other on one side in the lengthwise direction of the setting bar body portion 55. More specifically, the setting bar body portion 55 supports the plurality of electrical wire holding portions 52 described above such that the plurality of electrical wire holding portions 52 are arranged in the direction in which a pair of elastic sandwiching pieces 53 face each other. For example, the plurality of electrical wire holding portions 52 are preferably supported by being fitted into or onto the setting bar body portion 55. In addition, for example, a configuration in which the electrical wire holding portions 52 are separately fixed to the setting bar body portion 55 using screws or the like may be employed.

The setting bars 50 are detachably attached to the frame 21 using attachment portions. In this example, the setting bar body portion 55 are detachably attached to the second rail portions 32. For example, a portion of each setting bar body portion 55 is fitted into grooves 232a of second rail portions 32 such that the setting bar body portion 55 is interposed between the pair of second rail portions 32. Thus, the connector bars 30 and the setting bars 50 are attached to the frame 21 such that the setting bars 50 are located forward of the connector bars 30. Consequently, the terminal-equipped electrical wires 12 can be located forward of the cavities 142 of the connectors 14.

Note that if the frame 21 is provided with a plurality of connector bars 30, the setting bars 50 may be provided forward of each of the connector bars 30, or provided forward of some of the connector bars 30. In particular, in the latter case, it is possible that one setting bar 50 is located forward of each of the plurality of connector bars 30 when the terminal-equipped electrical wires 12 are inserted into the connectors 14.

### Electrical Wire Checking Portion

The electrical wire checking portion 26 is configured to check that terminal-equipped electrical wires 12 are held by a setting bar 50 in a state where the setting bar 50 is attached to the frame 21. The electrical wire checking portion 26 can check that terminal-equipped electrical wires 12 are held by the setting bar 50 by checking the state of a pair of elastic sandwiching pieces 53 of the setting bars 50, for example. Specifically, the electrical wire checking portion 26 includes strain gauges 28 that are respectively provided for the pairs of elastic sandwiching pieces 53, and a control unit 29.

When an electrical wire end portion is held between a pair of elastic sandwiching pieces 53, the pair of elastic sandwiching pieces 53 elastically deform in directions away from each other, and thus strain is generated. By detecting a change in the electrical resistance value caused by the strain, the strain gauge 28 can check that the pair of elastic sandwiching pieces 53 has elastically deformed, that is, a terminal-equipped electrical wire 12 is held by the setting bar 50.

More specifically, each strain gauge 28 includes a metal member that is attached to elastic sandwiching pieces 53 such that strain is generated when the elastic sandwiching pieces 53 deform. Each strain gauge 28 outputs, for example, the electrical resistance value of the metal member, which changes due to the strain, to the control unit 29 as output data. The control unit 29 is constituted by a typical computer that includes a CPU, a RAM, a ROM, an input circuit unit, and so on. The ROM is constituted by, for example, a rewritable non-volatile semiconductor memory such as a flash memory, and generates deformation amount data that indicates the degree of deformation of the target elastic sandwiching pieces 53 based on output data, and stores therein, for example, programs that describe procedures for generating holding data that indicates whether a terminal-equipped electrical wire 12 is held or not based on the deformation amount data. Various kinds of well-known processing may be employed as processing that is performed to generate deformation amount data based on the electrical resistance value of a strain gauge 28.

Note that the configuration of the electrical wire checking portion 26 is not limited to the above-described configuration. For example, if each pair of elastic sandwiching pieces 53 are configured to be in contact with each other when an electrical wire end portion is not held and separate away from each other when an electrical wire end portion is held, the electrical wire checking portion can detect that a terminal-equipped electrical wire 12 is held by a setting bar 50 by detecting electrical conduction of a pair of elastic sandwiching pieces 53. Also, for example, the electrical wire checking portion may check that a terminal-equipped electrical wire 12 is held by the setting bar 50 using a pressure sensor that detects pressure generated by a corresponding pair of elastic sandwiching pieces 53. Also, for example, the electrical wire checking portion may check that a terminal-equipped electrical wire 12 is held by the setting bar 50 using a laser displacement meter that detects displacement caused by the elastic deformation of a pair of elastic sandwiching pieces 53. Also, for example, the electrical wire checking portion may be constituted by a camera that captures an image of an area around a pair of elastic sandwiching pieces 53.

### Manufacturing Method

Next, a method for manufacturing the wire harness 10 using the above-described wire harness assembling device 20 will be described.

### Attachment Operation

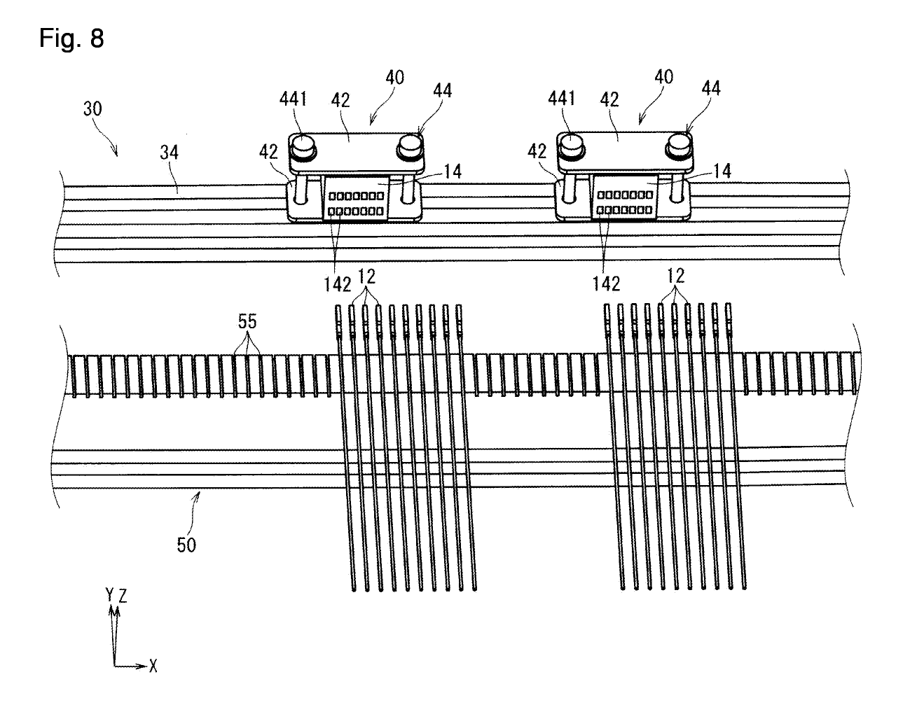

First, a frame 21 to which a connector bar 30 and a setting bar 50 are attached such that the setting bar 50 is located forward of the connector bar 30 is prepared (the step (a)). A plurality of connectors 14 are set to the connector bar 30 so as to match the shape of a wire harness 10 that is desired to be manufactured, and set a plurality of terminal-equipped electrical wires 12 that are to be inserted into the connectors 14 so as to be held by the setting bar 50 (the step (b)). FIG. 8 shows the situation after the step (a) and the step (b) have been completed. FIG. 8 illustrates the terminal-equipped electrical wires 12 that have been set to the setting bar 50. Note that the step (a) and the step (b), and tasks included in these steps are not necessarily performed in any specific order. Furthermore, after the step (b) has been performed, the fact that the terminal-equipped electrical wire 12 has been set to the setting bar 50 is checked (the step (f)).

In order to attach the connector bar 30 to the frame 21 and set the connectors 14 so as to be held by the connector bar 30, it is possible to set the connector bar 30 to which the connectors 14 have been set in advance, to the frame 21, or set the connectors 14 to the connector bar 30 that has been set to the frame 21. In this regard, the task of setting the connector holding parts 40 so as to be held by the connector bar 30 and the task of setting the connectors 14 so as to be held by the connector holding parts 40 may be performed one after the other or at the same time.

In order to set a connector holding part 40 so as to be held by the connector bar 30 and to set a connector 14 so as to be held by the connector holding part 40, specifically, sandwiching portions 42 are set to the connector bar 30 using bolts 441 and nuts 442 with the two sandwiching portions 42 sandwiching the connector 14. Thus, the connector holding parts 40 and the connectors 14 are held by the connector bar 30. Then, the connector bar 30 is attached to the frame 21. This task may be performed using a specific jig or the like, or with the operator's hand.

Note that the arrangement of the connectors 14 in the wire harness assembling device 20 may be set as appropriate. Here, the arrangement of the connectors 14 is set as follows, for example. That is, three or more connectors 14 that are connected to one primary branching point are two-dimensionally arranged when viewed in the direction in which the terminal-equipped electrical wires 12 are inserted. In this regard, it is preferable that the three or more connectors 14 are set in an arrangement that is similar to the relative positional relationship between the connectors 14 when mounted on a vehicle. This configuration makes it unnecessary to correct the relative positional relationship between three or more connectors 14 that are connected to the one primary branching point, after branches have been formed. As a result, it is possible to prevent electrical wires 121 from, for example, twisting when the relative positional relationship between three or more connectors 14 that are connected to the one primary branching point is corrected.

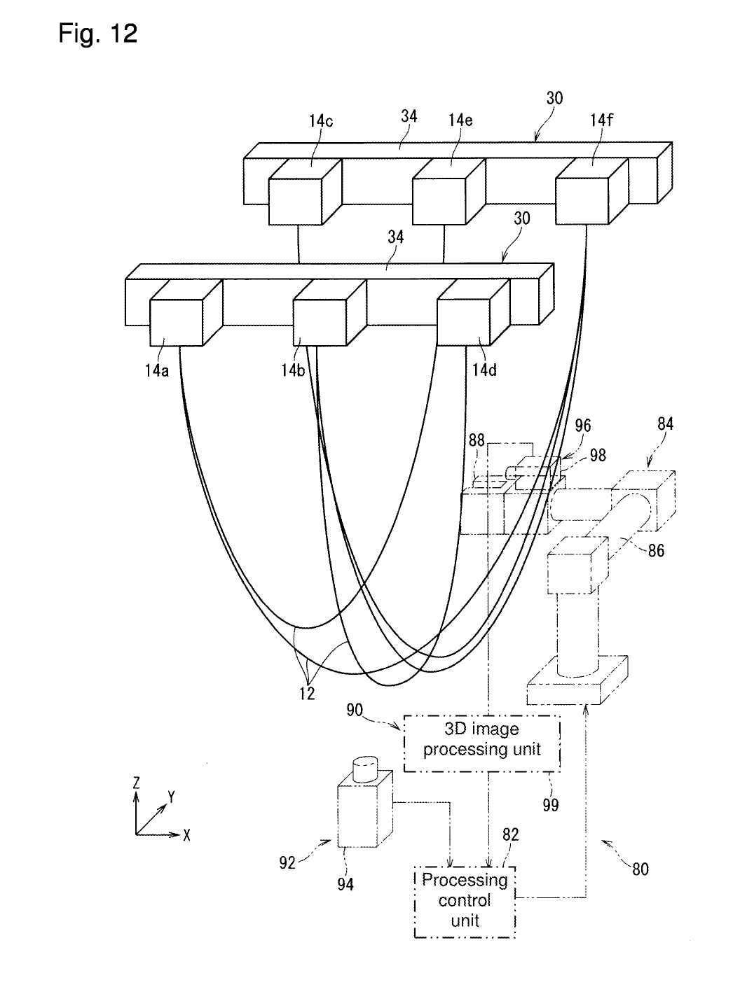

Specifically, as shown in FIG. 2, the connectors 14d, 14e, and 14f are connected to one primary branching point in this example. Two connectors 14 (the connectors 14e and 14f in this example) out of the three connectors 14d, 14e, and 14f are supported by one of the connector bars 30, and the remaining one connector 14 (the connector 14d in this example) is supported by the other of the connector bars 30 (see FIG. 12). That is, in the wire harness assembling device 20, the connector holding parts 40 that respectively support the connectors 14a, 14b, and 14d are supported by one of the connector bars 30, and the connector holding parts 40 that respectively support the connectors 14c, 14e, and 14f are supported by the other of the connector bars 30.

Of course, the arrangement of the connectors 14 is not limited to the above-described arrangement. For example, as in the modification described below, three or more connectors 14 that are connected to one primary branching point may be one-dimensionally arranged when viewed in the direction in which terminal-equipped electrical wires 12 are inserted. Also, even if the connectors 14 are arranged in the above-described arrangement, the connectors 14 need only be in the above-described arrangement when branches are formed, and are not necessarily in the above-described arrangement when terminal-equipped electrical wires 12 are inserted. That is, for example, the connectors 14 when terminal-equipped electrical wires 12 are inserted may be set in an arrangement in which the electrical wires 121 are unlikely to become tangled, and rearranged in the above-described arrangement after terminal-equipped electrical wires 12 have been inserted.

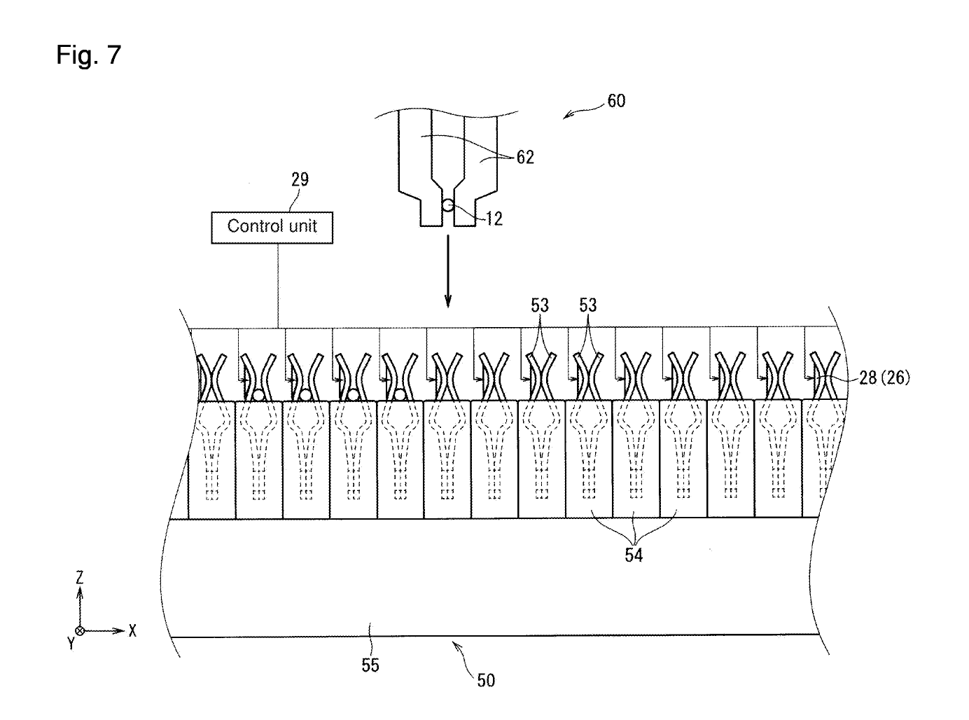

The setting bars 50 are set forward of the connector bars 30, specifically, on the side toward which the cavities 142 of the connectors 14 that are set to the connector bars 30 face, relative to the connector bars 30 (the negative side in the y axis direction relative to the connector bars 30 in the example shown in FIG. 3). When attaching the setting bars 50 to the wire harness assembling device 20 and setting the terminal-equipped electrical wires 12 so as to be held by the setting bars 50, it is possible to set the setting bars 50 to which the terminal-equipped electrical wires 12 have been set in advance, to the wire harness assembling device 20, or to set the terminal-equipped electrical wires 12 to the setting bars 50 that have been set to the wire harness assembling device 20. The task of setting the terminal-equipped electrical wires 12 to the setting bars 50 can be performed by, for example, directly setting the terminal-equipped electrical wires 12 that have been manufactured using a pressure-cutting device for manufacturing the terminal-equipped electrical wires 12. If this is the case, the terminal-equipped electrical wires 12 that have been manufactured using the pressure-cutting device may be set by an electrical wire transfer mechanism 60 that is located downstream of the pressure-cutting device as shown in FIG. 7, so as to be sequentially held by the electrical wire holding portions 52. The electrical wire transfer mechanism 60 may include, for example, a gripping portion 62 that grips a terminal-equipped electrical wire 12, and a moving mechanism that moves the gripping portion 62. Of course, the terminal-equipped electrical wires 12 may be set to the setting bars 50 by the operator's hand. Also, the terminal-equipped electrical wires 12 that have been manufactured using the pressure-cutting may be held by another member once and then be transferred from the other member to the setting bars 50.

When the terminal-equipped electrical wires 12 are set to the setting bars 50, it is preferable that electrical wire end portions that are to be inserted into predetermined connectors 14, out of the electrical wire end portions, are located forward of the predetermined connectors 14. As a result, the distance by which terminal-equipped electrical wires are moved when the terminal-equipped electrical wires are inserted can be shorter.

Also, when the terminal-equipped electrical wires 12 are set to the setting bars 50, the two ends of one terminal-equipped electrical wire 12 may be set to the same setting bar 50 or respectively set to different setting bars 50. More specifically, for example, when one terminal-equipped electrical wire 12 spans two connectors 14 that are set to the same connector bar 30, or when one setting bar 50 is used for a plurality of connector bars 30, the two ends of one terminal-equipped electrical wire 12 may be set to the same setting bar 50. Also, for example, when one setting bar 50 is dedicated to one connector bar 30 and one terminal-equipped electrical wire 12 spans two connectors 14 that are set to different connector bars 30, the two ends of one terminal-equipped electrical wire 12 may be respectively set to different setting bars 50.

After the terminal-equipped electrical wires 12 are held by the setting bars 50, the electrical wire checking portion 26 checks them. As described above, the electrical wire checking portion 26 checks that the terminal-equipped electrical wires 12 are held by the setting bars 50 by using the strain gauges 28 that output changes in the electrical resistances of the metal members caused by the deformation of the pairs of elastic sandwiching pieces 53. In this regard, the electrical wire checking portion 26 may only indicate the result of checking whether or not the electrical wire holding portions 52 hold electrical wire end portions, or notify the operator of an abnormality using, for example, means that provides a sensation to a sensory organ of the operator if an abnormality is found by comparing the result of the check with a timetable for production or the like.

### Electrical Wire Inserting Operation

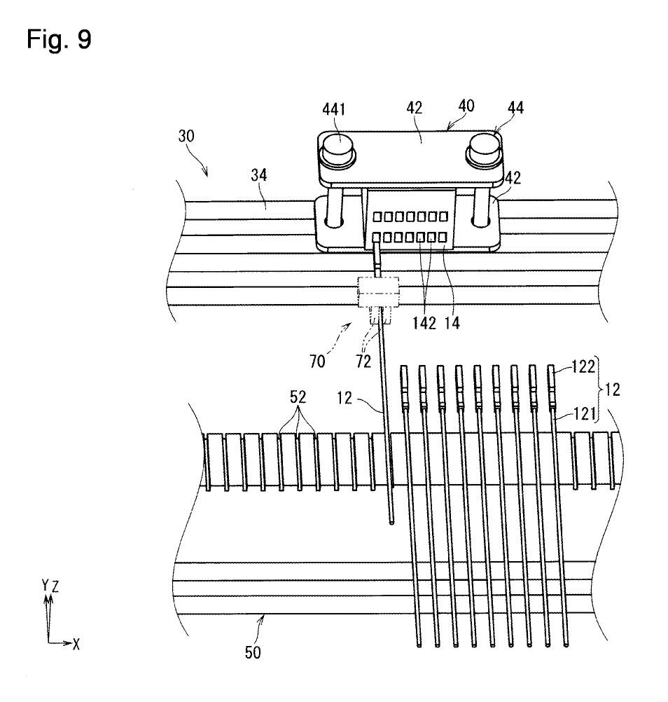

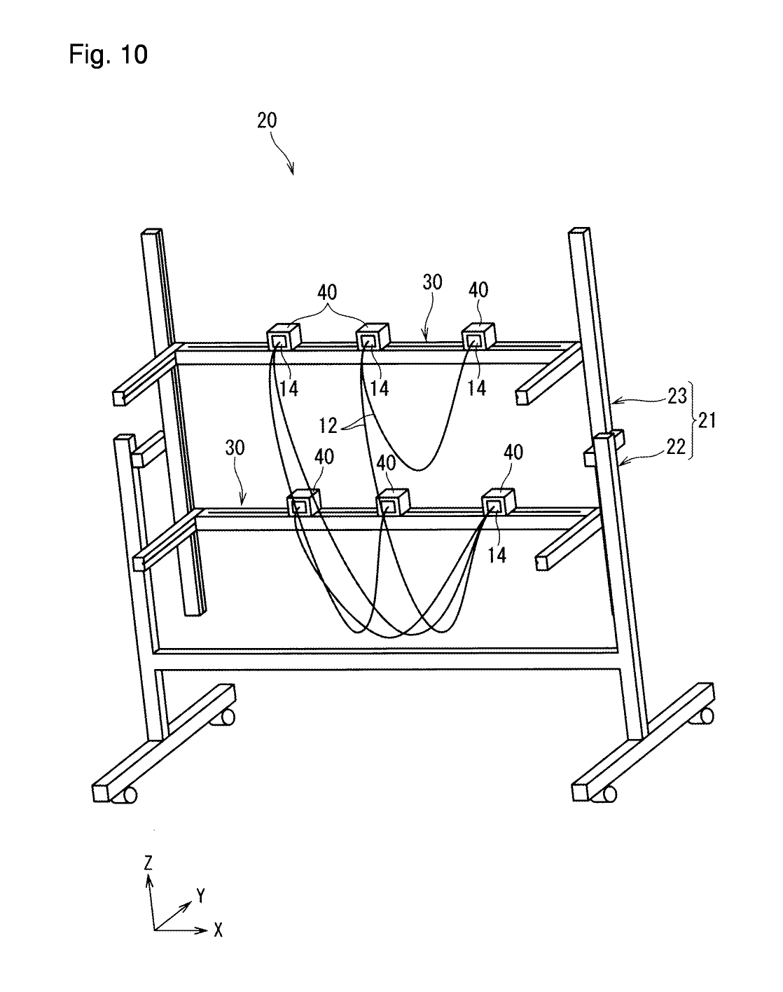

Next, operations according to the present embodiment that are performed to insert electrical wires 121 will be described with reference to FIGS. 9 and 10 in addition to FIGS. 7 and 8. FIG. 9 illustrates how terminal-equipped electrical wires 12 that have been set to a setting bar 50 are inserted into connectors 14 that have been set to a connector bar 30. FIG. 10 illustrates how the terminal-equipped electrical wires 12 are inserted into the connectors 14 that have been set to the connector bars 30. In this example, after the steps (a) and (b) have been performed, and after the step (f) has been performed, the terminal-equipped electrical wires 12 that are held by the setting bars 50 are inserted into the connectors 14 (the step (c)).

Specifically, the terminal-equipped electrical wires 12 that have been set to the setting bars 50 are sequentially set to the connectors 14 that have been set to the connector bars 30, with the setting bars 50 to which the terminal-equipped electrical wires 12 have been set and the connector bars 30 to which the connectors 14 have been set having been set to the wire harness assembling device 20. The terminal-equipped electrical wires 12 are inserted into the connectors 14 in the following manner, using an electrical wire inserting device 70, for example.

That is, a gripping portion 72 of the electrical wire inserting device 70 grips an end portion of a terminal-equipped electrical wire 12 that is fixed to the setting bar 50. Then, by driving a moving mechanism that moves the gripping portion 72, the end portion of the terminal-equipped electrical wire 12 that is gripped by the gripping portion 72 is moved to a position that is forward of the opening of a cavity 142 that is provided in a connector 14, and is then inserted into the cavity 142. Through these operations, the terminal-equipped electrical wire 12 that is set to the setting bar 50 is inserted into the cavity 142.

By repeating the above-described operations, it is possible to sequentially insert the terminal-equipped electrical wires 12 into a plurality of cavities 142. After the predetermined terminal-equipped electrical wires 12 have been inserted into the connectors 14 attached to the wire harness assembling device 20, the step of processing electrical wires is performed.

In this regard, it is preferable that the plurality of connectors 14 that have been set to one connector bar 30 are gathered by sliding the connectors 14 along the connector bar 30 in a direction in which the connector bar 30 extends. As a result, the distance by which the gripping portion 72 of the electrical wire inserting device 70 is moved can be short, and the time required to perform operations relating to the insertion of electrical wires can be reduced. In this regard, since the buffer portion 46 is provided, the connector 14 is unlikely to be released from the sandwiched state when the bolt 441 is slightly unfastened in order to slide the connector holding part 40 relative to the connector bar 30. Also, it is preferable that the state of the connectors 14 is changed from the state of being able to slide relative to the connector bar 30 to the state of being unable to slide relative to the connector bar 30 when the electrical wire insertion operation is performed. As a result, the connectors 14 do not move while the electrical wire insertion operation is performed, and it is possible to prevent an insertion error or the like from occurring.

Of course, it is not essential that the terminal-equipped electrical wires 12 are inserted into the connectors 14 using the electrical wire inserting device 70. The terminal-equipped electrical wires 12 may be inserted into the connectors 14 that are attached to the wire harness assembling device 20 by the operator's hand.

It is preferable that the setting bars 50 not holding the terminal-equipped electrical wires 12 as a result of all of the terminal-equipped electrical wires 12 held by the setting bars 50 having been inserted into the connectors 14 are removed from the wire harness assembling device 20 as shown in FIG. 10. If this is the case, setting bars 50 not holding terminal-equipped electrical wires 12 may be removed one by one while the operation to insert the terminal-equipped electrical wires 12 into the connectors 14 is performed, or all the setting bars 50 are removed after the operation to insert the terminal-equipped electrical wires 12 into the connectors 14 have been completed. The setting bars 50 need only be removed before the step of processing electrical wires is performed.

### Step of Processing Electrical Wires

The following describes, as an example of the step of processing electrical wires, an operation that is performed by an electrical wire group processing device 80 to form branching points of electrical wires. In this example, the wire harness assembling device 20 that has finished the terminal insertion is transferred to the electrical wire group processing device 80. Then, the electrical wire group processing device 80 forms branches from the electrical wires 121 that dangle from the connectors 14. That is, after the step (c) is performed, branches from the terminal-equipped electrical wires 12 that extend from the connectors 14 are formed (the step (d)).

The following describes the electrical wire group processing device 80 with reference to FIG. 12. FIG. 12 illustrates the electrical wire group processing device 80 according to the embodiment. Note that in FIGS. 12 to 14, the frame 21, the connector holding parts 40, and so on are omitted from the wire harness assembling device 20.

The electrical wire group processing device 80 includes a processing robot 84, a processing control unit 82, and an image acquisition system 90.

The processing robot 84 is a typical industrial robot. FIG. 12 shows a typical vertically multi-jointed robot. The processing robot 84 includes a robot arm 86 and a processing operation unit 88 that is provided at a leading end portion of the robot arm 86. The robot arm 86 has a configuration in which a plurality of arm portions are coupled to each other with joint mechanisms therebetween so as to be rotatable about their respective shafts The processing operation unit 88 is provided at a leading end portion of the robot arm 86. The processing robot 84 operates the robot arm 86 to move the processing operation unit 88 to any position relative to the wire harness assembling device 20 installed to the electrical wire group processing device 80, in any orientation.

The processing operation unit 88 performs processing including processing for forming branches from the electrical wires 121. In this example, the processing operation unit 88 performs, as processing for forming branches, processing for collecting portions of electrical wires 121 at predetermined positions in the direction in which the electrical wires 121 extend, to a certain position (bundling up intermediate portions of a plurality of electrical wires 121 in the direction in which the electrical wires 121 extend), and processing for keeping the electrical wires 121 in the collected state. In this example, it is assumed that processing for tying a plurality of electrical wires 121 together (e.g. winding an adhesive tape there around) is performed as processing for keeping the electrical wires 121 in the collected state.

To perform the former process, a known robot hand that can grip and move an electrical wire 121 to a certain position, and that can grip and collect a plurality of electrical wires 121 can be used as the processing operation unit 88. To perform the latter process, a known automatic tape winder can be used as the processing operation unit 88.

In order to perform a plurality of types of processing operations, a plurality of processing robots 84 may be provided. Alternatively, a plurality of processing operation units 88 may be provided at a leading end of the robot arm 86 so as to be movable relative to each other.

Note that the processing robot 84 may be a vertically multi-jointed robot, a rectangular coordinate type robot, or the like. The processing operation unit is changed as appropriate according to the operation that is to be performed on the electrical wires.

The processing control unit 82 is constituted by a typical computer that includes a CPU, a RAM, a ROM, an input circuit unit, and so on. The ROM is constituted by, for example, a rewritable non-volatile semiconductor memory such as a flash memory, and stores therein, for example, programs that describe procedures for determining the area to be processed and the position, orientation, and so on of the objects to be processed (electrical wire group) based on image data that has been acquired by the image acquisition system 90, and processing procedures and the details of the processes that are to be performed on the electrical wires. The CPU executes the programs that are stored in the ROM, thereby performing processes to provide the processing robot 84 with various instructions, to perform various processes on the electrical wires based on the image data acquired by the image acquisition system 90.

The image acquisition system 90 is a system for acquiring image data that is used to recognize the electrical wires that constitute the above-described wire harness 10, and, for example, includes a two-dimensional vision system 92, which is a first vision system, and a three-dimensional vision system 96, which is a second vision system.

The two-dimensional vision system 92 is configured to acquire first image data that is used to recognize the electrical wires that constitute the wire harness 10, within a first image capturing range.

That is, the two-dimensional vision system 92 includes a two-dimensional camera 94. The two-dimensional camera 94 is supported by a camera supporting member or the like, at a distance from the connector holding parts 40, for example, on a frame 21 of the wire harness assembling device 20, and is provided so as to be able to capture images of the entire area of the wire harness assembling device 20, in which the electrical wires are expected be provided, as the first image capturing range. The first image data acquired by the two-dimensional vision system 92 is given to the processing control unit 82.

The three-dimensional vision system 96 is configured to acquire, regarding the electrical wires that constitute the wire harness 10, second image data that has a greater amount of information per unit area compared to the first image data, within a second image capturing range that overlaps the first image capturing range and is smaller than the first image capturing range.

In this example, the three-dimensional vision system 96 includes a stereo camera 98 that includes a plurality of cameras, and a three-dimensional image processing unit 99. The image capturing range of the stereo camera 98 is smaller than the above-described first image capturing range. The stereo camera 98 is attached to a leading end portion of the robot arm 86 of the processing robot 84, at a position where the stereo camera 98 does not interfere with the processing operation unit 88. Therefore, the stereo camera 98 can capture an image of the electrical wires within the second image capturing range that overlaps the first image capturing range and is smaller than the first image capturing range.

The stereo camera 98 captures images of the second image capturing range R2 from different directions, and outputs the image data thus obtained to the three-dimensional image processing unit 99. The three-dimensional image processing unit 99 is constituted by a typical computer that includes a CPU, a RAM, a ROM, an input circuit unit, and so on. The ROM is constituted by, for example, a rewritable non-volatile semiconductor memory such as a flash memory, and stores therein, for example, programs that describe procedures for generating three-dimensional data (point group data) of the electrical group that is to be processed, as the second image data, based on a plurality of pieces of image data obtained by capturing images of the second image capturing range from different directions. Then, the second image data thus obtained by the three-dimensional image processing unit 99 is output to the processing control unit 82. Various kinds of known processing for generating three-dimensional point group data based on a plurality of pieces of image data obtained from different positions, using the principles of triangulation, may be employed as processing for generating three-dimensional data based on images obtained by the stereo camera 98. Note that the stereo camera 98 does not necessarily have a plurality of cameras, and may be configured to obtain a plurality of pieces of image data in different directions by moving one camera.

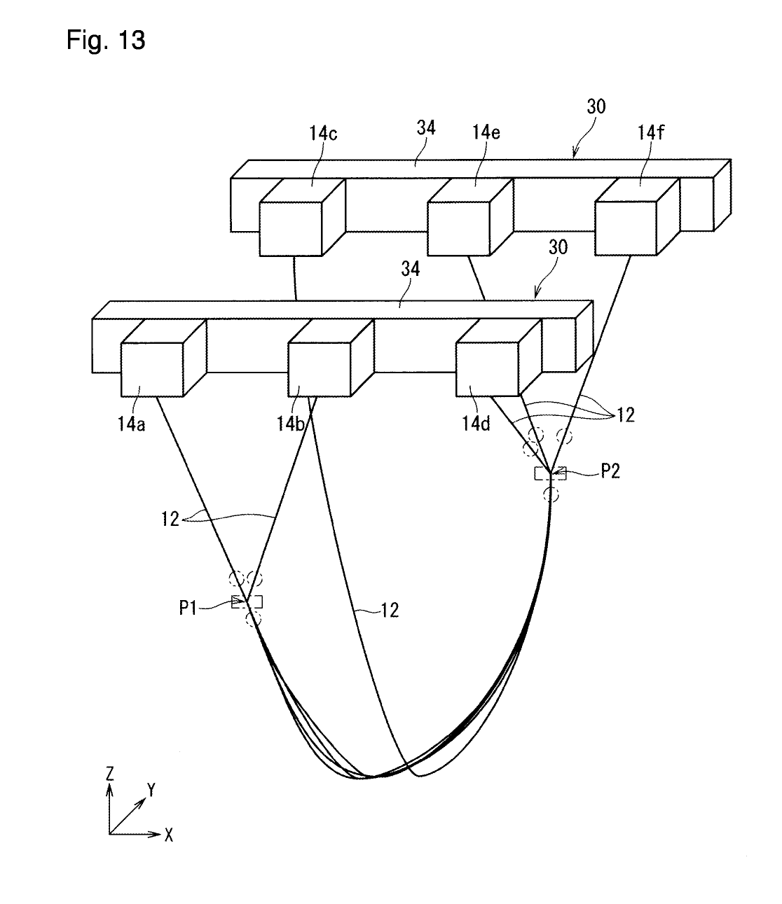

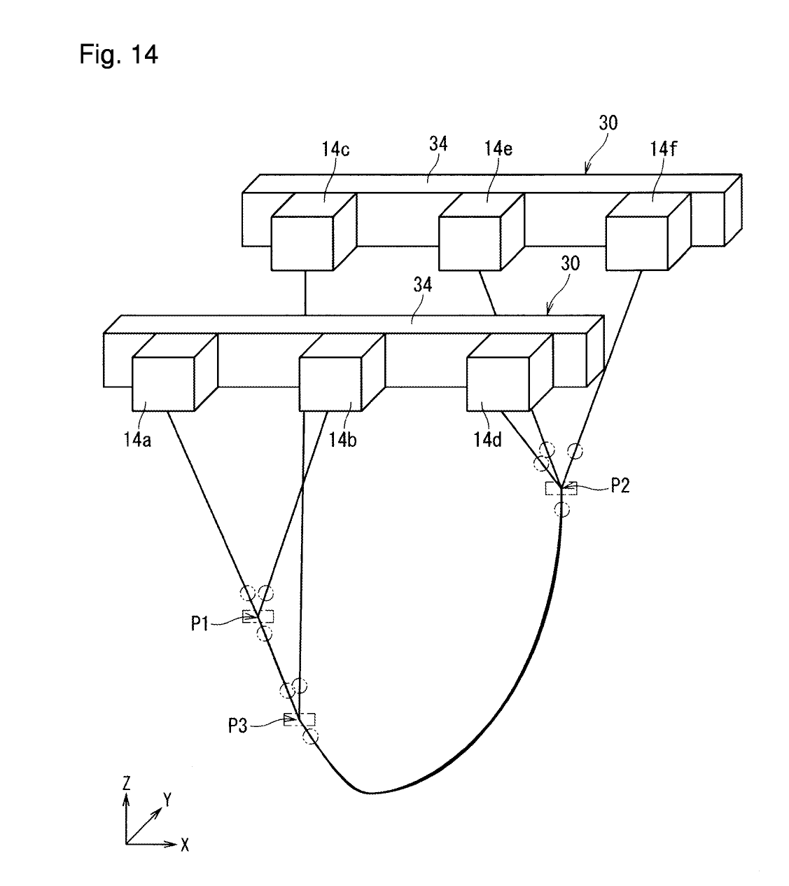

The following more specifically describes an example in which the electrical wire group processing device 80 forms branches from electrical wires with reference to FIGS. 13 and 14 in addition to FIG. 12. FIG. 13 illustrates how primary branching points are formed in electrical wires 121. FIG. 14 illustrates how secondary branching points are formed in electrical wires 121.

First, in the initial state, as shown in FIG. 12, the connectors 14 to which end portions of electrical wires are connected are supported by the connector holding parts 40 attached to the wire harness assembling device 20. The electrical wires 121 between the connectors 14 each dangle in a U-like shape. In this regard, the orientations of the connector bars 30 are set such that the openings of the cavities 142 of the connectors 14 face downward in the vertical direction. Also, after the electrical wires have been inserted, the state of the connectors 14 is changed from the state of being unable to slide relative to the connector bars 30 to the state of being able to slide relative to the connector bars 30, and the connectors 14 are appropriately positioned on the connector bars 30 according to the shape of the wire harness 10 that is desired to be manufactured, by sliding the connectors 14 relative to the connector bars 30 in the direction in which the connector bars 30 extend. Thus, the terminal-equipped electrical wires 12 are routed according to the shape of the wire harness 10 that is desired to be manufactured.

In this state, the two-dimensional vision system 92 acquires the first image data of the first image capturing range that includes the electrical wires. In this example, it is assumed that the first image data is captured from a position that is downward in the vertical direction. The first image data thus acquired includes the electrical wires that extend from the connectors 14 along a horizontal plane.

Here, it is assumed that processing for forming branches from the electrical wires that extend from the connectors 14a and 14b, at positions that are at a certain distance from the connectors 14a and 14b (positions that correspond to the branching position P1), has been defined as the first processing that is to be performed on the electrical wires. In this regard, since the connectors 14 are supported by the wire harness assembling device 20, they can be treated as being located at known positions.

In this case, the electrical wires 121 are recognized by performing image processing such as edge extraction processing on the first image data, and the second image capturing range is determined so as to include portions of the electrical wires 121 that extend from the connector 14a and the connector 14b, the portions being located within the above-described distance. Thus, the area to be processed (the second image capturing range) can be determined within the first image capturing range.

Thereafter, the robot arm 86 of the processing robot 84 moves the stereo camera 98 to a position at which the stereo camera 98 can capture images of the second image capturing range. Then, the three-dimensional vision system 96 that includes the stereo camera 98 acquires the second image data of the second image capturing range.

Then, the routes of the electrical wires 121 with reference to the position of the connector 14a (14b), which is at a known position, are tracked based on the second image data, and positions that are at the above-described certain distance from the connector 14a (14b) (the positions in circles in FIG. 13) are specified. Portions at these positions are to be bundled up so as to form a branching point. Since the second image data is three-dimensional data, the positions of the electrical wires 121 in the y axis direction can be also specified. Then, an instruction to collect the portions of the electrical wires 121 at the above-described positions to one position is given to the processing robot 84. In this case, the portions of the electrical wires 121 at the above-described positions may be collected to one position using separate robot hands. Alternatively, the plurality of electrical wires 121 may be collected to one position using one robot hand. Even in the latter case, it is possible to collect the portions of the electrical wires 121 at the above-described positions can be collected to one position by adjusting the position at which the connector 14a (14b) is supported and pulling out the electrical wires 121 from the connectors 14a (14b) and bundling up the electrical wires 121.

Thereafter, the collected state of the electrical wires 121, in which the electrical wires 121 extend from the positions to which the electrical wires 121 are collected, is kept. In this example, the electrical wires 121 are tied together as described above in order to maintain the collected state. That is, since the one position to which the electrical wires 121 are collected is a known position to which the electrical wires 121 have been moved by the robot hand, portions that extend from the position to the connectors 14a and 14b and portions that extend below the connectors 14a and 14b are tied together. The task of tying can be performed using an automatic tape winder attached to the robot arm 86 as described above.

When this task of tying is performed, the positions or the like of the electrical wires 121 are different from those when the entire image was captured, and therefore it is preferable that the second image data is captured again using the three-dimensional vision system 96, and the positions to be processed or the like are specified again using the second image data.

Subsequently, branches from the plurality of electrical wires 121 that extend from the remaining connectors 14 are also formed in the same manner as described above. In this example, branches are formed at predetermined positions (positions corresponding to the branching position P2) of the plurality of electrical wires 121 that extend from the connector 14d, the connector 14e, and the connector 14f.

The state after this processing has been performed is as shown in FIG. 13. In FIG. 13, a branching point is indicated by a square that is drawn with a two-dot chain line, and portions that are tied together are indicated by circles that are drawn with two-dot chain lines. As shown in FIG. 13, branches are formed in the plurality of electrical wires 121 that extend from the connectors 14a, 14b, 14d, 14e, and 14f, at the branching positions P1 and P2 that are close to the connectors 14a, 14b, 14d, 14e, and 14f.

Subsequently, branches from the plurality of electrical wires 121 are formed between the branching positions P1 and P2 that have been formed. In this example, the task of forming branches from the plurality of electrical wires 121 is performed such that electrical wires 121 that extend from the trunk line 131 that is a bundle of a large number of electrical wires 121 are connected to the connector 14c.

Again, the first image data is acquired first using the two-dimensional vision system 92, the electrical wires 121 are recognized by performing image processing such as edge extraction processing on the first image data, and the second image capturing range is determined so as to include portions of the electrical wires 121 that extend from the branching position P1 or P2 and portions of the electrical wires 121 that extend from the connector 14c, the portions being located within a certain distance, depending on the details of the subsequent process (e.g. which portion out of the electrical wires 121 between the branching positions P1 and P2 should be tied together).

Thereafter, the robot arm 86 of the processing robot 84 moves the stereo camera 98 to a position at which the stereo camera 98 can capture images of the second image capturing range. Then, the three-dimensional vision system 96 that includes the stereo camera 98 acquires the second image data of the second image capturing range.

Then, the routes of the electrical wires 121 with reference to the position of the connector 14c and the already-formed branching positions P1 and P2 (the branching positions P1 and P2 are specified as known positions or positions to which the electrical wires 121 are collected from a plurality of positions in the second image data) are tracked based on the second image data, and positions that are at a certain distance from the connector 14c and positions that are at a certain distance from the already-formed branching positions P1 and P2 in any direction are specified. Portions at these positions are to be bundled up in the trunk line 131. Then, an instruction to collect the portions of the electrical wires 121 at the above-described positions to one position using the processing robot 84 is given. Thereafter, portions of the electrical wires 121 around the above-described positions, at which the electrical wires 121 are bundled up, are tied together.

As a result of the plurality of electrical wires 121 being bundled at positions between the branching positions P1 and P2, as shown in FIG. 14, the plurality of electrical wires 121 are divided into branches at the plurality of branching positions P1, P2 and P3, and are tied together. Thus, the wire harness 10 can be manufactured.

If necessary, it is possible to attach a clamp part for fixing the wire harness 10 to a vehicle, a protector for protecting the wire harness 10, an exterior part such as a corrugated tube, and the like may be attached to the wire harness 10 using the processing robot 84 or by hand.

According to the present embodiment, the wire harness assembling device 20 includes: a connector bar 30 that has a rod shape and to which a plurality of connectors 14 can be set; a setting bar 50 that is configured to hold a plurality of terminal-equipped electrical wires 12; and a frame 21 to which at least one set composed of a connector bar 30 and a setting bar 50 is attached such that the setting bar 50 is located forward of the connector bar 30. Therefore, the terminal-equipped electrical wires 12 held by the setting bar 50 can be inserted into the connectors 14 that have been set to the connector bar 30. By setting the arrangement of the connectors 14 so as to correspond to the shape of the wire harness 10 that is desired to be manufactured, it is possible to set the positional relationship between the terminal-equipped electrical wires 12 so as to correspond to the wire harness 10, at the same time as inserting the terminals 122. Furthermore, it is possible to form branches from the terminal-equipped electrical wires 12 that extend from the connectors 14 that have been set to the connector bar 30. With the above-described configuration, it is possible to perform both the step of inserting terminals 122 and the step of performing wiring, without transferring the wire harness 10 or the electrical wires 121 included therein between the steps. Also, since the position of the setting bar 50 relative to the connector bar 30 is fixed, it is possible to improve accuracy regarding the insertion of electrical wires, and to prevent an insertion error from occurring.

If a large number of connectors 14 are included in the wire harness 10 and a plurality of tiers of connector bars 30 are provided so that the connectors 14 can be positioned according to the shape of wire harness 10 that is desired to be manufactured, it is possible to prevent the terminal-equipped electrical wires 12 from becoming tangled by passing under each other.

By separating the step of setting the terminal-equipped electrical wires 12 so as to be held by the setting bar 50 and the step of inserting the terminal-equipped electrical wires 12 into the connectors 14 from each other, it is possible to simplify the functions of the automatic machines in each step, and reduce the costs of the facility.

The wire harness assembling device 20 also includes attachment portions that enable the setting bar 50 to be detachably attached to the frame 21. Therefore, by removing the setting bar 50 from the frame 21 after the terminals 122 have been inserted, it is possible to prevent the setting bar 50 from hindering the operation that is performed to form branches points after the terminals 122 have been inserted.

The wire harness assembling device 20 also includes the electrical wire checking portion 26 that is configured to check that the terminal-equipped electrical wires 12 are held by the setting bar 50 that is in the state of being attached to the frame 21. Therefore, it is possible to prevent, for example, an error from occurring when the terminal-equipped electrical wires 12 are inserted into the connectors 14, thereby preventing defective products from being manufactured.

The connectors 14 are provided so as to be slidable relative to the connector bar 30 in the direction in which the connector bar 30 extends, and so as to be able to change the state thereof between a slidable state and a non-slidable state. Therefore, the connectors 14 can be brought into the non-slidable state when the connectors 14 are desired to be non-slidable such as when the terminals 122 are inserted, and can be brought into the slidable state when the connectors 14 are desired to be slidable such as when branches are formed.

### Modifications

In the embodiment, connector holding parts 40 of one type are used for a plurality of types of connectors 14 that have different sizes, for example. However, this is not essential. The connector holding parts 40 may be specifically designed for each of the connectors 14.

Although the present invention has been described in detail above, the descriptions are to be considered in all respects as illustrative, and the present invention is not limited to the descriptions. It should be understood that innumerable modifications that are not illustrated herein can be envisaged without departing from the scope of the present invention.

### LIST OF REFERENCE NUMERALS

10: Wire Harness
12: Terminal-equipped Electrical Wire
14: Connector
20: Wire Harness Assembling Device
21: Frame
26: Electrical Wire Checking portion
30: Connector Bar
40: Connector Holding Part
42: Sandwiching Portion
421: Bolt Insertion Hole
44: Fixing Portion
441: Bolt
442: Nut
46: Buffer Portion
50: Setting Bar
52: Electrical Wire Holding Portion
55: Setting Bar Body Portion
70: Electrical Wire Inserting Device
80: Electrical Wire Group Processing Device
84: Processing Robot
90: Image Acquisition System

1. A wire harness assembling device comprising:
a connector bar having a rod shape and to which a plurality of connectors can be set;
a setting bar having a rod shape and configured to hold a plurality of terminal-equipped electrical wires;
a frame to which at least one set composed of the connector bar and the setting bar is attached such that the setting bar is located forward of the connector bar; and
an electrical wire checking portion configured to check that terminal-equipped electrical wires are held by the setting bar that is attached to the frame.

2. The wire harness assembling device according to claim 1, further comprising:
an attachment portion configured to enable the setting bar to be detachably attached to the frame.

3. (canceled)

4. The wire harness assembling device according to claim 1,
wherein the connectors are configured to be slidable relative to the connector bar in a direction in which the connector bar extends, and to change between a slidable condition and a non-slidable condition.

5. A wire harness manufacturing method comprising:
preparing a frame to which a connector bar and a setting bar are attached such that the setting bar is located forward of the connector bar;
setting a plurality of connectors to the connector bar according to a shape of a wire harness that is desired to be manufactured, and setting a plurality of terminal-equipped electrical wires so as to be held by the setting bar;
checking that the terminal-equipped electrical wires are held by the setting bar;
thereafter inserting the terminal-equipped electrical wires into the connectors; and
thereafter forming branches from the terminal-equipped electrical wires that extend from the connectors.

6. The wire harness manufacturing method according to claim 5,
wherein the setting bar is detachably attached to the frame, and
the wire harness manufacturing method further comprises removing the setting bar from the frame after inserting the terminal-equipped electrical wires into the connectors, and before forming branches from the terminal-equipped electrical wires that extend from the connectors.

7. (canceled)

8. The wire harness manufacturing method according to claim 5, further comprising:
sliding the connectors relative to the connector bar in a direction in which the connector bar extends; and
changing a condition of the connectors between a condition of being slidable relative to the connector bar and a condition of not being slidable relative to the connector bar.
